(19) United States
(12) Patent Application Publication
(10) Pub. No.: US 2021/0267235 A1
(43) Pub. Date: Sep. 2, 2021

(54) FOOD ADDITIVE TO ENHANCE ANIMAL PERFORMANCE AND METHOD OF USING THE SAME

(71) Applicant: Vitech Bio-Chem Corporation, Orange, CA (US)

(72) Inventor: Thomas Shau Shieh, Orange, CA (US)

(73) Assignee: Vitech Bio-Chem Corporation, Orange, CA (US)

(21) Appl. No.: 17/186,757

(22) Filed: Feb. 26, 2021

Related U.S. Application Data
(60) Provisional application No. 62/983,351, filed on Feb. 28, 2020.

(51) Int. Cl. A23K 20/147; A23K 20/20; A23K 50/30

(52) U.S. Cl. CPC A23K 20/147; A23K 50/30; A23K 20/30

(57) ABSTRACT

Feed supplements comprising a fish-derived hydrolysate peptide composition and zinc oxide and animal food product containing the feed supplement are provided herein. Also provided are methods of feeding swine by supplying the feed supplement or a swine food product made therefrom to swine. The swine may be nursery piglets and the feed may be supplied at weaning and lead to better growth, better food intake and increased feed conversion. The swine may also be gestating or nursing sows.

### CROSS-REFERENCE TO RELATED APPLICATIONS

This application claims priority to U.S. Provisional Application No. 62/983,351 filed on Feb. 28, 2020, the contents of which are incorporated by reference in their entireties.

### STATEMENT REGARDING FEDERALLY FUNDED RESEARCH OR DEVELOPMENT

Not applicable.

### INTRODUCTION

In pigs, weaning stress results from changes in diet form and social interaction, such as introduction to a competing dominance order and isolation from dam. Weaning stress often results in a reduction in food intake and disruptions in intestinal barrier integrity. These changes in the gut allow opportunistic pathogenic bacteria to dominate the commensal microflora community and can lead to post-weaning diarrhea, growth retardation, and even death. The swine industry is looking for alternative ingredient(s) to replace SDPP since it may carry potential harm to swine industry. This study showed that Peptiva can deliver the utility that SDPP provides to piglets and shows that Peptiva can deliver a better economic return as well when used.

To attenuate the negative impacts of the weaning process, early nursery diets are typically formulated using ingredients that are highly bioavailable and palatable, as to stimulate food intake. For example, spray-dried plasma protein (SDPP) from a porcine or bovine source has been used in nursery diets since the late 1980s, and has been shown to improve performance and reduce diarrhea in weaned pigs by increasing feed intake. However, the relatively high cost of this ingredient and a desire by some producers to reduce the use of animal products in their feed have prompted the industry to look for alternatives to SDPP. Another reason pig producers would like to replace SDPP is its potential role in the spread of African Swine Fever (ASF) virus. The use of SDPP is suspected by some to be one of the causes of wide spread of the disease in Asia. The increase in recent social demands for organic meats may also be a force for pork producers desire to replace animal protein like SDPP as feed ingredient while some see fish products are accepted as exemption.

Thus, there is a need in the art for improved post-weaning diets for piglets that stimulate food intake to avoid the negative impacts of the weaning process.

### SUMMARY

The present work is directed to a feed supplement that satisfies the need of providing swine with food that allows pigs to increase voluntary feed consumption and reduce weaning stress in nursery pigs.

In one aspect, the present invention provides a feed supplement comprising a fish-derived hydrolysate peptide composition and zinc oxide. In some embodiments, the fish-derived hydrolysate peptide composition comprises 50-60 wt % of protein, 4-5.5 wt % of fat, and/or 2-3 wt % of fiber.

In another aspect, the present invention provides a swine food product. The swine food product comprises the feed supplement described herein. In one embodiment, the swine food product contains 2-5 wt % of the feed supplement.

In another aspect, the present invention provides methods for feeding swine by supplying the feed supplement or the swine food product to swine. In one embodiment, the feeding swine are nursery piglets, gestating sows, and/or lactating sows.

These and other features, objects, and advantages of the present invention will become better understood from the description that follows. In the description, reference is made to the accompanying drawings, which form a part hereof and in which there is shown by way of illustration, not limitation, embodiments of the invention. The description of preferred embodiments is not intended to limit the invention to cover all modifications, equivalents and alternatives. Reference should therefore be made to the claims recited herein for interpreting the scope of the invention.

### BRIEF DESCRIPTION OF THE DRAWINGS

These and other features, aspects, and advantages of the present invention will become better understood with regard to the following description, appended claims, and accompanying drawings.

FIG. 1 is a graph showing average daily weight gain in kg/day for pigs fed a positive control (PC) diet, negative control (NC) diet, Peptiva diet (NC+3% Peptiva), or Peptiva+zinc oxide (ZnO) diet (NC+3% Peptiva+ZnO) over the course of three phases of growth.

FIG. 2 is a graph showing average weight gain over each phase of growth in pigs fed the indicated diets.

FIG. 3 is a graph showing the average daily feed intake for pigs fed the indicated diet in each phase of growth.

### DETAILED DESCRIPTION

To attenuate the negative impacts of the weaning process, early nursery diets are typically formulated using ingredients that are highly bioavailable and palatable, as to stimulate food intake. In has been suggested that porcine derived hydrolysate peptides increase voluntary feed consumption in nursery pigs. Studies have shown that piglets prefer diets comprising hydrolysate peptides as compared to whey-based diets (Solà-Oriol et al., 2011), but dislike hydrolysate peptide diets as compared to lactose-based diets (Figueroa et al., 2016). Fish-derived hydrolysate peptides, such as Peptiva (Vitech Bio-Chem, Corp, CA), were reported to improve food intake. These data are in agreement with findings of Norgaard et al., (Nørgaard et al., 2012), which showed that such diets effectively restored weight gain as compared to diets comprising spray dried plasma protein (SDPP). This was especially true when the amino acids were provided in an ideal balanced ratio. In addition, the economic return was higher when a Peptiva diet was used as compared to when a SDPP diet was used. Field trials suggest that combination of Peptiva and probiotics/prebiotic could potentially have synergetic effects.

In the present application, the inventor describes his surprising discovery that fish-derived hydrolysate peptides can be used to replace SDPP in piglet diets. Further, the inventor demonstrates that fish-derived hydrolysate peptides can be combined with zinc oxide (ZnO) to improve performance in a synergistic manner, increase complete blood cell count, and alter the microbiome community of swine. Accordingly, the present invention provides a feed supplement that contains a fish-derived hydrolysate peptide composition and zinc oxide.

Fish-derived hydrolysate peptides are commercially available. Fish-derived hydrolysate peptide suppliers include, but are not limited to, Vitech Bio-Chem Corporation® (California, USA), Apelsa (Guadalajara, Mexico), Qingdao Future Group (Shangond, China), Mukka Seafood Industries Limited (India), Ocean Protein (Washington, USA), Omega Protein Corporation (Texas, USA), Daybrook Fisheries, Inc. (Louisiana, USA), and Blue Wave Marine (Lima, Peru).

The fish-derived hydrolysate peptide composition used in the feed supplement disclosed herein contains from 50 to 80 wt % of protein. The fish-derived hydrolysate peptide also contains from 4 to 8 wt % of fat and from 2 to 5 wt % of fiber.

In one aspect, the feed supplement also contains zinc oxide. Zinc oxide (ZnO) can be of pharmaceutical grade.

The feed supplement disclosed herein has a ratio of 1:7 to 10:7 by weight of fish-derived hydrolysate peptide composition to zinc oxide.

The feed supplement can be given to any suitable animal including, without limitation, swine, poultry, domestic pets, and aquacultures. Suitable poultry include starter chicken, growing/finishing broilers, layers, and turkeys.

Suitable swine include, but are not limited to, nursery piglets, breeding pigs, gestational sows, lactating sows, growing-finishing pigs, and starter pigs. The term “nursery piglets” is used to describe piglets ranging in age from those that have just been born to piglets that are about 65 days old. The standard practice in the swine industry is to wean piglets that are around 21 days old. Thus, the term “weaned piglets” refers to piglets that are at least about 21 days old. The term “gestational sows” is used to refer to pregnant sows that are at 93 days of gestation and up to 113 days of gestation or are farrowing. “Lactating sows” are sows that have given birth and/or are in the farrowing stage.

In some embodiments of the present invention, the feed supplement is given to nursery piglets that are about 21 days old up until they are about 63 days old. In other aspects of the invention, the feed supplement is given to gestational sows. In other embodiments of the invention, the feed supplement is given to lactating sows.

An animal food product is also disclosed herein. The animal food product may be a swine food product. The swine food product contains the feed supplement disclosed herein. In one aspect of the invention, the feed supplement comprises from 2 wt % to 5 wt % of the swine food product. In another aspect, the feed supplement comprises from 3 wt % to 4 wt % of the swine food product. The swine food product also comprises corn, soy, fat, and milk whey powder. The inventors have determined that the effective inclusion rate (dose) is between 50 gm/ton (0.005%) and 100 kg/ton (10%). Thus, the inclusion rate may be any rate from 100 gm/ton (0.01%) to 50 kg/ton (5.0%) or from 500 gm/ton to 10 kg/ton (0.5% to 1%). The pig feed formula may include limestone, vitamins, trace minerals, premix, enzyme, etc.

The swine food product can be given to any suitable animal including, but is not limited to, swine, poultry, domestic pets, and aquacultures.

In some embodiments of the invention, the swine food product is given to nursery piglets that are about 21 days old up until they are about 63 days old. In one embodiment of the invention, the swine food product is given to nursery piglets in three different phases, each phase lasting about 14 days. Phase I is a feeding period that starts when piglets are about 21 days old (i.e., at weaning) and ends when piglets are about 35 days old. Phase II begins when piglets are about 35 days old and continues until the piglets are about 49 days old. Phase III begins when piglets are about 49 days old and ends when piglets are about 63 days old.

In another embodiment, the swine food product is given to gestational sows. In another embodiment, the swine food product is given to lactating sows.

In some embodiments of the invention, the fish-derived hydrolysate peptide composition comprises from 0.01 wt % to 3.0 wt % of the total feed given to the swine. For example, the fish-derived hydrolysate peptide composition comprises from 5 kg to 25 kg per ton of complete feed. When feeding weaning piglets, the fish-derived hydrolysate peptide composition can comprise from 0.1 wt % to 3.0 wt %, or from 0.5 wt % to 2.5 wt % based on the total weight of the complete feed. When feeding starter pigs, the fish-derived hydrolysate peptide composition can comprise from 0.05 wt % to 1.5 wt %, or from 0.1 wt % to 1.0 wt % based on the total weight of the complete feed. When feeding growing-finishing pigs, the fish-derived hydrolysate peptide composition can comprise from 0.01 wt % to 1.0 wt %, or from 0.01 wt % to 0.5 wt % based on the total weight of the complete feed. When feeding gestational sows, the fish-derived hydrolysate peptide composition can comprise from 0.01 wt % to 1.0 wt %, or from 0.05 wt % to 0.5 wt % based on the total weight of the complete feed. When feeding lactating sows, the fish-derived hydrolysate peptide composition can comprise from 0.01 wt % to 1.0 wt %, or from 0.05 wt % to 0.5 wt % based on the total weight of the complete feed.

Methods for feeding swine by supplying the feed supplement disclosed herein or the swine food product disclosed herein are also provided herein.

Supplying may mean feeding the swine food product to nursery piglets, gestating sows, lactating sows, or other swine. It may also mean incorporating the feed supplement into a complete feed and feeding swine the complete feed. Supplying may also mean giving the feed supplement to swine.

The present inventor found that supplying the feed supplement or the swine food product to swine resulted in improvements in feed intake, weight gain, and born piglets weight as compared to feeding swine with industry standard feed or a swine food product that lacked the fish-derived hydrolysate peptide composition and zinc oxide.

The experiments presented in Example 1 demonstrate that when the feed supplement or the swine food product disclosed herein are fed to nursery piglets, the nursery piglets showed an increase in average daily gain, an increase in body weight, an increase in average daily feed intake, an increase in the ratio of weight gain to feed, a reduction in energy expenditure (this phrase is supported by the improved weight/feed ratio), or a combination thereof compared to nursery piglets that were fed with feed supplement or food product lacking the fish-derived hydrolysate peptide composition and zinc oxide.

The experiments presented in Example 2 demonstrate that when gestating sows were fed the feed supplement or the swine food product disclosed herein, the gestating sows showed an increase in sow weight or an increase in the sow weight at farrowing compared to gestating sows that were fed with feed supplement or food product lacking the fish-derived hydrolysate peptide composition and zinc oxide. Additionally, gestating sows fed with the feed supplement or the swine food product disclosed herein gave birth to piglets that had an increased birth weight and birthed fewer dead piglets compared to gestating sows that were fed with feed supplement or food product lacking the fish-derived hydrolysate peptide composition and zinc oxide.

Further experiments showed that lactating sows fed with the feed supplement or the swine food product disclosed herein showed an increase in feed intake compared to lactating sows that were fed with feed supplement or food product lacking the fish-derived hydrolysate peptide composition and zinc oxide. Additionally, the lactating sows fed with the feed supplement or the swine food product disclosed herein showed decreased weight loss compared to lactating sows that were fed with feed supplement or food product lacking the fish-derived hydrolysate peptide composition and zinc oxide.

These experiments also showed that piglets born and/or feeding from gestational sows/lactating sows fed with the feed supplement or the swine food product disclosed herein showed an increase in weaning weight, average daily gain, or a combination thereof compared to piglets born from gestational sows/lactating sows that were fed with feed supplement or food product lacking the fish-derived hydrolysate peptide composition and zinc oxide. Further, piglets born and/or feeding from gestational sows/lactating sows fed with the feed supplement or the swine food product disclosed herein showed an increase in pre-weaning piglet survival, a decrease in the number of piglets requiring transfer, or a decrease in weaned pigs weighing less than 7 pounds compared to piglets born from gestational sows/lactating sows that were fed with feed supplement or food product lacking the fish-derived hydrolysate peptide composition and zinc oxide.

The term “treated sows” refers to gestational sows and/or lactating sows that were fed with the feed supplement or swine food product disclosed herein.

As used herein, the terms include and including have the same meaning as the terms comprise and comprising in that these latter terms are open transitional terms that do not limit claims only to the recited elements succeeding these transitional terms. The term consisting of, while encompassed by the term comprising, should be interpreted as a closed transitional term that limits claims only to the recited elements succeeding this transitional term. The term consisting essentially of, while encompassed by the term comprising, should be interpreted as a partially closed transitional term which permits additional elements succeeding this transitional term, but only if those additional elements do not materially affect the basic and novel characteristics of the claim.

The Examples provided below are meant to be illustrative and not to limit the scope of the invention or the claims. All references and appendices cited herein are hereby incorporated by reference in their entireties.

### EXAMPLES

### Example 1. Use of Peptiva in Nursery Pig Diet

### Introduction

In pigs, weaning stress results from changes in diet form and social interaction, such as introduction to a competing dominance order and isolation from dam. Weaning stress often results in a reduction in food intake and disruptions in intestinal barrier integrity. These changes in the gut allow opportunistic pathogenic bacteria to dominate the commensal microflora community and can lead to post-weaning diarrhea, growth retardation, and even death. Thus, to attenuate the negative impacts of the weaning process, early nursery diets are typically formulated using ingredients that are highly bioavailable and palatable, as to stimulate food intake.

In has been suggested that porcine derived hydrolysate peptides increase voluntary feed consumption in nursery pigs. Studies have shown that piglets prefer diets comprising hydrolysate peptides as compared to whey-based diets (Solà-Oriol et al., 2011), but dislike hydrolysate peptide diets as compared to lactose-based diets (Figueroa et al., 2016). Fish-derived hydrolysate peptides, such as Peptiva (Vitech Bio-Chem, Corp, CA), were reported to improve food intake. These data are in agreement with findings of Norgaard et al., (Nørgaard et al., 2012), which showed that such diets effectively restored weight gain as compared to diets comprising spray dried plasma protein (SDPP). This was especially true when the amino acids were provided in an ideal balanced ratio. In addition, the economic return was higher when a Peptiva diet was used as compared to when a SDPP diet was used. Field trials suggest that combination of Peptiva and probiotics/prebiotic could potentially have synergetic effects.

Thus, in the following Example, we investigated whether Peptiva can be used to replace SDPP and/or zinc oxide (ZnO) in piglet diets, and whether a combination of these components would have a synergistic effect on outcomes such as performance, complete blood cell count, and the microbiome community.

### Materials and Methods

Nursery phase: A total of 288 PIC C-29 X PIC 380 pigs were used for the study. The pigs were approximately 21 days of age and were sourced from the University of Arkansas Animal Science Swine Research Farm.

Treatment allotments: The pigs were individually weighed and sorted at weaning. To avoid the confounding effect of initial weight, the pigs were assigned to eight blocks by weight as determined by the experimental facility (8 blocks with 36 pigs per block). Eight replicates per treatment were performed in each phase. Pigs were housed six pigs/pen. An attempt was made to balance sex within blocks such that each treatment is represented by an equal number of each sex within a block. Pigs remained in the same pens throughout the experiment.

Treatment arrangement: Pigs were given a dietary treatment over three different phases of growth (detailed below). Pigs remained on the same dietary treatment throughout the whole study period.
Phase 1: 6-8 kg (feed for 14 days)
Phase 2: 8-14 kg (feed for 14 days)
Phase 3: 14-22 kg (feed for 14 days)

Phase 1, 2 and 3 treatments: In each phase, one of four dietary treatments was fed to each pig. Treatment 1, a moderately complex diet comprising spray dried plasma protein (SDPP), served as a positive control (“PC”). Treatment 2, a diet devoid of SDPP and zinc oxide (ZnO) and using feed grade amino acids to meet amino acid requirements, served as a negative control (“NC”). In Treatment 3, SDPP and ZnO are replaced with 3% Peptiva. Treatment 4 is the same diet as that of Treatment 3 with added ZnO. The compositions of these diets are detailed in Table 1, below.

TABLE 1
Nursery Diet Compositions.

| University of | | | | | | | NC + 3.0% | NC + 3.0% |
|---|---|---|---|---|---|---|---|---|
| Arkansas | | | | | NC + 3.0% | NC + 3.0% | Peptiva + | Peptiva + |
| PICC29 × PIC | PC | | NC | | Peptiva | Peptiva | ZnO | ZnO |
| 380 | Body Wt | | Body Wt | | Body Wt | Body Wt | Body Wt | Body Wt |
| Trial: 2017 | 8 to 12 Lbs | | 12 to 20 Lbs | | 12-20 Lbs | 12-20 Lb | 12-20 Lb | 12-20 Lb |
| Peptiva SEW | 12 to 20 Lbs | | (Ave 16 Lb) | | (Ave 16 Lb) | (Ave 16 Lb) | (Ave 16 Lb) | (Ave 16 Lb) |
| Ingredients | Lbs | % | Lbs | % | Lbs | % | Lbs | % |
| Corn, Yellow | 638.86 | 31.94 | 691.12 | 34.56 | 634.93 | 31.75 | 628.53 | 31.43 |
| Dent | | | | | | | | |
| Soybean meal, | 450.00 | 22.50 | 450.00 | 22.50 | 450.00 | 22.50 | 450.00 | 22.50 |
| 48%, high | | | | | | | | |
| protein, dehulled, | | | | | | | | |
| sol extracted | | | | | | | | |
| Corn DDGS, >6 | 0.00 | 0.00 | 0.00 | 0.00 | 0.00 | 0.00 | 0.00 | 0.00 |
| and <9% Oil | | | | | | | | |
| Poultry Fat | 60.00 | 3.00 | 60.00 | 3.00 | 60.00 | 3.00 | 60.00 | 3.00 |
| Monocalcium P | 23.30 | 1.165 | 27.00 | 1.350 | 27.00 | 1.350 | 27.00 | 1.350 |
| Limestone | 17.50 | 0.875 | 16.00 | 0.800 | 16.00 | 0.800 | 16.00 | 0.800 |
| Salt | 5.00 | 0.250 | 5.00 | 0.250 | 5.00 | 0.250 | 5.00 | 0.25 |
| L-Lysine | 4.980 | 0.249 | 9.580 | 0.479 | 7.60 | 0.380 | 7.50 | 0.380 |
| DL-Methionine | 4.10 | 0.205 | 5.76 | 0.288 | 5.920 | 0.296 | 5.920 | 0.296 |
| L-Threonine | 0.830 | 0.042 | 3.220 | 0.161 | 2.350 | 0.118 | 2.350 | 0.118 |
| L-Tryptophan | 0.370 | 0.019 | 1.110 | 0.056 | 0.810 | 0.041 | 0.810 | 0.041 |
| ZnO | 6.400 | 0.320 | 0.00 | 0.00 | 0.00 | 0.00 | 6.400 | 0.320 |
| Copper Sulfate | 0.00 | 0.00 | 0.00 | 0.00 | 0.00 | 0.00 | 0.00 | 0.00 |
| Trace Mineral | 3.000 | 0.15 | 3.000 | 0.15 | 3.000 | 0.15 | 3.000 | 0.15 |
| Premix (NB- | | | | | | | | |
| 8534) | | | | | | | | |
| Vitamin Premix | 5.000 | 0.25 | 5.000 | 0.25 | 5.000 | 0.25 | 5.000 | 0.25 |
| (NB-6508) | | | | | | | | |
| Plasma (AP-920) | 60.000 | 3.000 | 0.000 | 0.000 | 0.000 | 0.000 | 0.000 | 0.000 |
| Fish Meal, | 0.00 | 0.00 | 0.00 | 0.00 | 0.00 | 0.00 | 0.00 | 0.00 |
| Menhaden | | | | | | | | |
| Milk, Whey | 550.00 | 27.50 | 550.00 | 27.50 | 550.00 | 27.50 | 550.00 | 27.50 |
| Powder | | | | | | | | |
| Peptiva Swine | 0.00 | 0.00 | 0.00 | 0.00 | 60.00 | 3.00 | 60.00 | 3.00 |
| Ethoxiquin | | | | | | | | |
| (Quinguard) | 0.60 | 0.03 | 0.600 | 0.030 | 0.600 | 0.030 | 0.600 | 0.030 |
| L-Valine | 0.00 | 0.00 | 2.550 | 0.128 | 1.730 | 0.087 | 1.730 | 0.087 |
| SynGeriX | 0.00 | 0.00 | 0.00 | 0.00 | 0.00 | 0.00 | 0.00 | 0.00 |
| Milk, Lactose | 70.00 | 3.50 | 70.00 | 3.50 | 70.00 | 3.50 | 70.00 | 3.50 |
| Ronozyme | 0.060 | 0.003 | 0.060 | 0.003 | 0.060 | 0.003 | 0.060 | 0.003 |
| HiPhos 2700 | | | | | | | | |
| (GT) | | | | | | | | |
| Soycomil-P | 100.00 | 5.00 | 100.00 | 5.00 | 100.00 | 5.00 | 100.00 | 5.00 |
| ADM | | | | | | | | |
| Total | 2000 | 100 | 2000 | 100 | 2000 | 100 | 2000 | 100 |

Measurements: Individual pig weights and pen feed intake data were collected and used to calculate average daily weight gain, feed intake, and gain-to-feed ratio by growth phase.

Blood samples were collected into a K2EDTA tube from a median bodyweight (BW) pig from each pen and 1 mL of whole blood was aspirated into a micro-centrifuge tube for a complete blood cells count using a Hemavet instrument. Afterward, the remaining sample was centrifuged and the plasma was aspirated into a 5 mL sample storage tube and stored at −20° C. for blood urea nitrogen (BUN) testing.

Rectal swabs samples were collected from a median BW pigs on day 0, 14, 28 and 42 and were used to characterize the microbiome populations using high-throughput sequencing (MiSeq). The sequencing data were analyzed using the mothur software. Sequences were aligned with the Silva reference database and taxonomy was classified against a 16S rRNA reference (RDP) database.

### Results

Table 2 shows the effect that adding Peptiva to the diets of nursery pigs had on performance.

TABLE 2
Performance of nursery pigs (LS means) fed one of four dietary treatments.

| | | | NC + 3% | NC + 3% | | |
|---|---|---|---|---|---|---|
| | PC | NC | Peptiva | Peptiva + ZnO | SEM | Trt |
| ADG, kg/d | | | | | | |
| Phase 1 | 0.041 | 0.038 | 0.038 | 0.058 | 0.013 | 0.5406 |
| Phase 2 | 0.284^{b} | 0.225^{a} | 0.231^{a} | 0.331^{c} | 0.015 | <0.0001 |
| Phase 3 | 0.587 | 0.581 | 0.551 | 0.582 | 0.018 | 0.2257 |
| Phase 1 & 2 | 0.196^{bc} | 0.158^{a} | 0.162^{ab} | 0.231^{c} | 0.013 | <0.0001 |
| Overall | 0.348^{bc} | 0.322^{ab} | 0.313^{a} | 0.368^{c} | 0.011 | <0.0001 |
| BW, kg | | | | | | |
| Initial | 6.44 | 6.45 | 6.35 | 6.43 | 0.38 | 0.3019 |
| End of phase 1 | 6.76 | 6.75 | 6.66 | 6.89 | 0.34 | 0.3997 |
| End of phase 2 | 10.74^{b} | 9.93^{a} | 9.89^{a} | 11.52^{c} | 0.43 | <0.0001 |
| End of phase 3 | 18.96^{bc} | 18.06^{ab} | 17.60^{a} | 19.71^{c} | 0.63 | <0.0001 |
| ADFI, kg/d | | | | | | |
| Phase 1 | 0.153 | 0.162 | 0.152 | 0.157 | 0.016 | 0.9759 |
| Phase 2 | 0.346^{ab} | 0.307^{a} | 0.319^{a} | 0.416^{c} | 0.020 | 0.0002 |
| Phase 3 | 0.840^{x} | 0.835^{x} | 0.826^{x} | 0.949^{y} | 0.040 | 0.0671 |
| Phase 1 & 2 | 0.276^{ab} | 0.255^{ab} | 0.258^{a} | 0.322^{c} | 0.017 | 0.0075 |
| Overall | 0.495^{ab} | 0.481^{ab} | 0.470^{ab} | 0.566^{c} | 0.022 | 0.0069 |
| G:F | | | | | | |
| Phase 1 | 0.232 | 0.181 | 0.195 | 0.351 | 0.085 | 0.2963 |
| Phase 2 | 0.825^{d} | 0.722^{abc} | 0.716^{ab} | 0.776^{bcd} | 0.023 | 0.0013 |
| Phase 3 | 0.714^{b} | 0.698^{b} | 0.670^{ab} | 0.610^{a} | 0.023 | 0.0462 |
| Phase 1 & 2 | 0.708^{b} | 0.606^{a} | 0.611^{a} | 0.700^{b} | 0.025 | 0.0004 |
| Overall | 0.710^{y} | 0.668^{xy} | 0.651^{x} | 0.642^{x} | 0.017 | 0.0664 |

^{abcd}LS means with superscript different significant differ (P < 0.05)
^{x.y.z}LS means with superscript different tend to be differ (0.05 < P ≤ 0.10)
ADG = Average Daily Gain.
BW = Body weight.
ADFI = Average daily feed intake.
G:F = Gain:Feed ratio.
TRT = treatment and
SEM: standard error of the mean.

Table 3 shows the effect that incorporating Peptiva into the diets of nursery pigs had on their blood cell counts.

TABLE 3
Complete blood cell count in nursery pigs (LS means) fed one of four dietary
treatments.

| | | | | | | | |
|---|---|---|---|---|---|---|---|
| | | NC + 3% | NC + 3% | | | | |
| PC | NC | Peptiva | Peptiva + ZnO | SEM | Trt | Day | Trt*Day |

Concentration, k/μl

| | | | | | | | | |
|---|---|---|---|---|---|---|---|---|
| WBC | 14.60 | 13.02 | 15.35 | 14.05 | 0.78 | 0.3334 | <0.0001 | 0.3506 |
| Neutrophil | 5.26 | 5.02 | 6.13 | 5.09 | 0.49 | 0.6337 | <0.0001 | 0.2639 |
| Lymphocyte | 7.06 | 6.10 | 7.00 | 6.83 | 0.34 | 0.1104 | <0.0001 | 0.7228 |
| Monocyte | 0.69 | 0.65 | 0.63 | 0.69 | 0.06 | 0.9476 | <0.0001 | 0.6990 |
| Eosinophil | 1.49 | 1.20 | 1.49 | 1.35 | 0.13 | 0.4199 | <0.0001 | 0.5777 |
| Basophil | 0.10 | 0.06 | 0.11 | 0.09 | 0.01 | 0.1899 | 0.0008 | 0.5227 |

Percentage over WBC

| | | | | | | | | |
|---|---|---|---|---|---|---|---|---|
| Neutrophil | 35.03 | 37.29 | 37.36 | 35.98 | 1.52 | 0.4833 | <0.0001 | 0.5501 |
| Lymphocyte | 49.89 | 48.72 | 48.67 | 49.39 | 1.55 | 0.6389 | <0.0001 | 0.4166 |
| Monocyte | 4.78 | 4.77 | 4.19 | 4.59 | 0.36 | 0.8343 | <0.0001 | 0.8443 |
| Eosinophil | 9.59 | 8.73 | 9.03 | 9.39 | 0.78 | 0.8635 | <0.0001 | 0.5578 |
| Basophil | 0.72 | 0.49 | 0.75 | 0.61 | 0.10 | 0.2801 | <0.0001 | 0.4184 |
| NLR | 73.72 | 80.75 | 90.18 | 75.97 | 7.02 | 0.4571 | <0.0001 | 0.6421 |
| RBC, M/μl | 7.06 | 6.98 | 7.03 | 6.90 | 0.13 | 0.9022 | <0.0001 | 0.8640 |
| Hemoglobin, | 9.10 | 8.90 | 9.04 | 9.06 | 0.21 | 0.7716 | <0.0001 | 0.3537 |
| g/dL | | | | | | | | |
| Hematocrit, % | 34.16 | 34.02 | 34.67 | 33.86 | 0.61 | 0.8516 | <0.0001 | 0.4418 |
| MCV | 48.50 | 48.83 | 49.46 | 49.29 | 0.74 | 0.8748 | <0.0001 | 0.0128 |
| MCH, Pg | 12.94 | 12.77 | 12.90 | 13.19 | 0.32 | 0.7510 | <0.0001 | 0.1172 |
| MCHC, g/dL | 26.68 | 26.08 | 26.08 | 26.72 | 0.38 | 0.3585 | <0.0001 | 0.6165 |
| RDW, % | 32.30 | 31.54 | 33.41 | 31.70 | 0.71 | 0.0191 | <0.0001 | 0.2692 |
| PLT, k/μl | 434.16 | 557.92 | 504.67 | 568.83 | 30.37 | 0.0061 | <0.0001 | 0.6780 |
| MPV, fL | 8.49 | 8.94 | 9.08 | 8.84 | 0.31 | 0.5299 | <0.0001 | 0.7650 |

MCV = Mean corpuscular volume: average of red cells.
MCH = Mean corpuscular hemoglobin: hemoglobin amount per red blood cell.
MCHC = Mean corpuscular hemoglobin concentration: hemoglobin amount relative to size of hemoglobin per red blood cell.
RDW = Red cell distribution width: calculation of variation in size of red blood cell.
PLT = platelet.
MPV = Mean platelet volume: calculation average size of platelets.
NLR = Neutrophil lymphocyte ratio.
TRT: treatment and
SEM: Standard error mean.

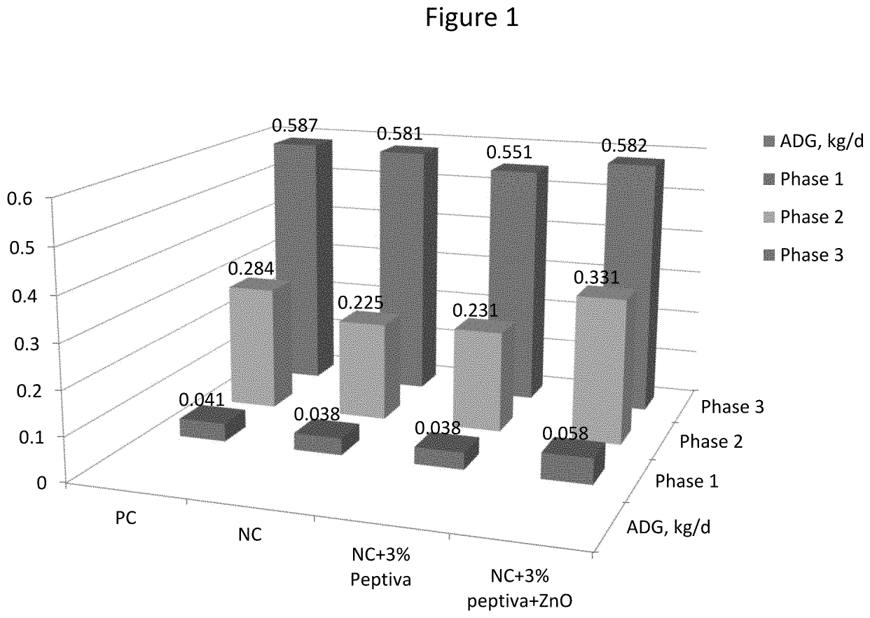

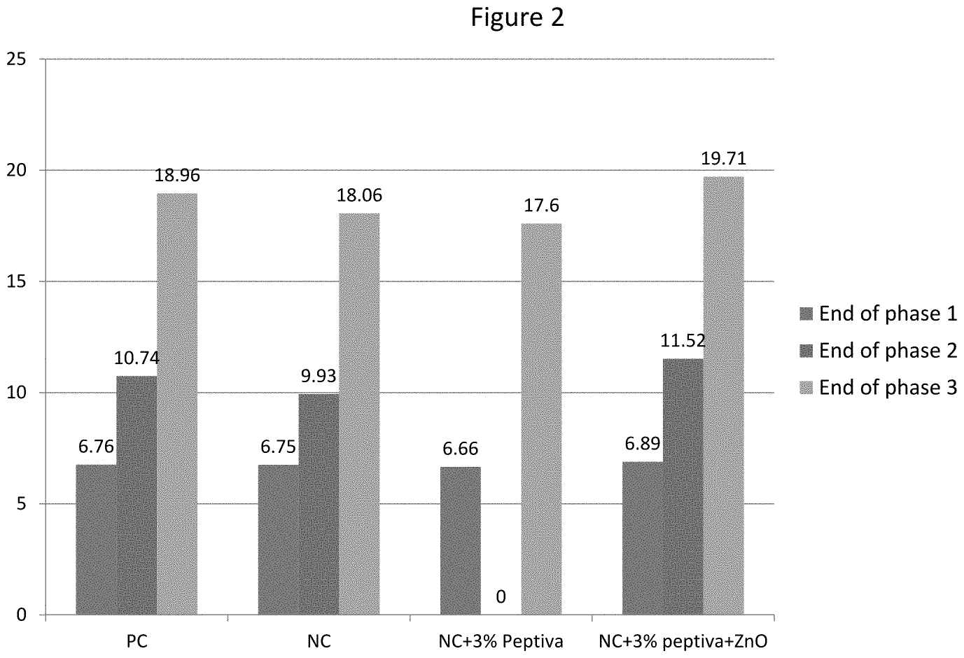

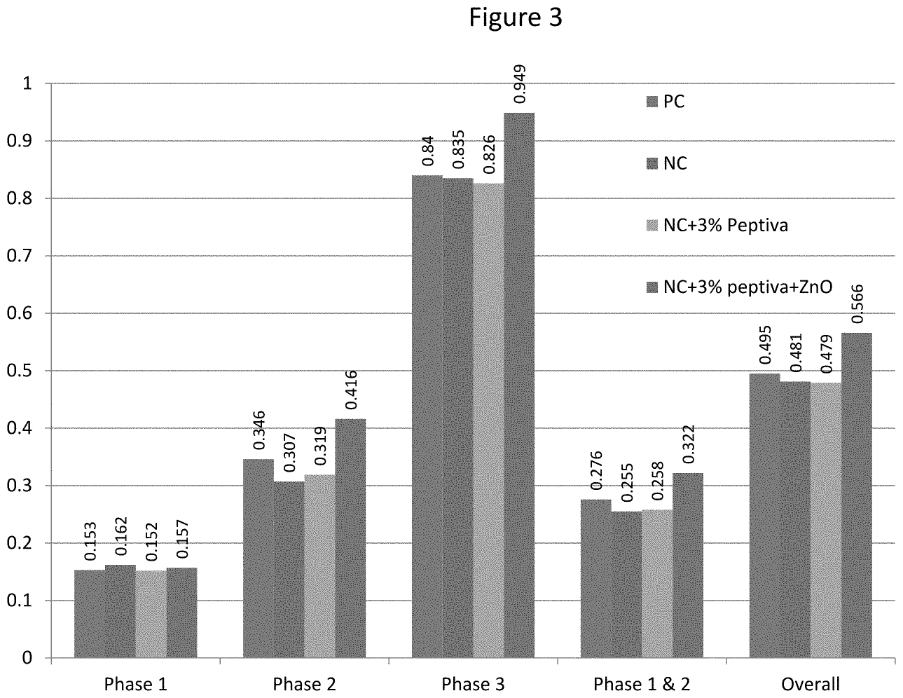

FIG. 1 shows the average daily weight gain for nursery pigs fed the indicated diets. These data show that supplementing the diet with Peptiva or Peptiva+ZnO resulted in statistically significant increases in daily weight gain. These effects were apparent over the course of the study, as is shown in FIG. 2, which shows the total weight gain over each of the indicated growth phases. FIG. 3 shows the average daily feed intake for pigs fed the indicated diet in each phase of growth. These results indicate that the pigs fed diets supplemented with Peptiva and ZnO outperformed the pigs fed the other tested diets.

This study demonstrates that supplementation with Peptiva significantly improves several outcomes in piglets, including average daily weight gain and average daily feed intake. We show that Peptiva can be used to replace spray dried plasma protein (SDPP) in piglet diets, providing a better economic return than SDPP when use in combination with a high dose of pharmaceutical grade zinc oxide.

### REFERENCES

Anjum N., Maqsood S., Masud T., Ahmad A., Sohail A., Momin A. (2014) Lactobacillus acidophilus: Characterization of the Species and Application in Food Production. Critical Reviews in Food Science and Nutrition 54:1241-1251. DOI: 10.1080/10408398.2011.621169.
Broadway P. R., J. A. Carroll, N. C. Burdick Sanchez, B. E. Bass, Frank J. W. (2016) Supplementation of a Lactobacillus acidophilus fermentation product can attenuate the acute phase response following a lipopolysaccharide challenge in pigs. Journal of Animal Science 94 (suppl. 2) 144.
Figueroa J., Solà-Oriol D., Guzmán-Pino S. A., Chetrit C., Borda E., Pérez J. F. (2016) The use of porcine digestible peptides and their continuity effect in nursery pigs1. Journal of Animal Science 94:1531-1540. DOI: 10.2527/jas.2015-0019.
Lan R. X., J. M. Koo, S. I. Lee, J. H Cho, I. H. Kim. (2016) Effects of Lactobacillus acidophilus fermentation product on growth performance, nutrient digestibility, and fecal microbiota in weanling pigs. Journal of Animal Science 94 (suppl. 2).
Nørgaard J. V., Blaabjerg K., Poulsen H. D. (2012) Salmon protein hydrolysate as a protein source in feed for young pigs. Animal Feed Science and Technology 177:124-129. DOI: http://doi.org/10.1016/j.anifeedsci.2012.08.003.
Solà-Oriol D., Roura E., Torrallardona D. (2011) Feed preference in pigs: Effect of selected protein, fat, and fiber sources at different inclusion rates1. Journal of Animal Science 89:3219-3227. DOI: 10.2527/jas.2011-3885.
Stern N.J., C. W. Hesseltine, H. L. Wang, Konishi F. (1977) Lactobacillus acidophilus utilization of sugars and production of a fermented soybean product. Journal Articles, USDA Authors, Peer-Reviewed 10.

### Example 2. Effect of Peptiva Swine on Sow's Reproductive Performance and Longevity

In the Following Study, we Evaluated the Effect of Adding Peptiva Swine to Late Gestation and lactation diets on sows' reproductive performance, milk yield, and milk composition.

### Materials and Methods

Two consecutive breed groups of breeding age gilts and sows (approximately 42 breeding females in each group, PIC C-29 pigs) were used in this study. The gilts and sows were given the same treatments through two subsequent farrowing cycles to evaluate the effects of feeding Peptiva Swine during gestation and lactation on the reproductive performance and longevity of gilts and sows.

Sows were housed in gestation stalls after weaning, and replacement gilts and the sows that were not being weaned were placed on MATRIX™ (MERCK Animal Health) for two weeks starting 21 days prior to the expected time of breeding to synchronize cycling. After completing a farrowing cycle, an attempt was made to have the sows rebred for a subsequent farrowing cycle. Replacement gilts were introduced to the herd to ensure that a total of 38 to 40 sows and gilts were included in each group. Gilts that were not being bred were moved back into the gilt/sow pool for the subsequent breeding group. All sows and gilts were weighed, blocked by weight and parity, and randomly allotted to one of two dietary treatments. Typically, the breeding facility attempts to breed 38 pigs in cool seasons and 42 pigs during summer in an attempt to farrow 30 to 35 in each group. Sows and gilts remained on the same treatment throughout of the study.

Gestation: All sows were fed a common gestation diet until 30 days prior to farrowing. On day 93 of gestation, gilts/sows were sorted by body weight and parity and allotted to one of two dietary treatments. During the first 100 days of gestation, gilts and sows were fed approximately 5 lb/head/day once daily followed by approximately 6 lbs/head/day for the remainder of gestation. These feedings were made according to standard practices, taking into account environment and body condition. It is a common practice to attempt to feed to a common body condition score based on the Herd Manager's daily observations. A record system was established in an attempt to quantify the number of sow days that sows received an increase or a decrease in feed intake and the amount of the increase or decrease. Feed offered sows identified as needing more feed were increased by 0.5 or 1.0 lbs. of feed/day and feed offered sows identified as needing less feed were decreased by 0.5 or 1.0 lbs. of feed/day. Data was summarized to indicate, by treatment, the number of sow days that sows received either a 0.5 or 1.0 lb. per day increase or decrease in feed offered. Gilts and sows were weighed at the initiation of treatment after breeding, and at 110 days of gestation or when they were moved to farrowing.

Lactation: Gilts and sows were fed the lactation diet starting at the time they were moved to the farrowing facility and the amount of fed remained approximately 5 lbs., once daily until parturition. Within 24 hours of parturition, gilts and sows were offered feed at least two times daily and were fed to appetite. Feed intake was recorded, and average daily feed intake was calculated weekly.

Gestation treatments: Gestation diets were initiated at day 93 of gestation and continued through day 110 of gestation. The compositions of these diets are detailed in Table 4, below. Diets were fed in the meal form. The two gestation treatments were as follows:
Gestation Treatment 1: Control−moderately complex diet.
Gestation Treatment 2: Treatment 1+Peptiva Swine.

TABLE 4
Gestation diet compositions.

| | University of Arkansas | | | |
|---|---|---|---|---|
| | PIC C29 × PIC 380 | | | |
| | Trial: Vitech Sows | | | |
| | Control | | Peptiva Swine | |
| | Gilt/Sow | | | |
| Ingredients | Lbs | % | Lbs | % |
| Corn, Yellow Dent | 1172.73 | 58.64 | 1163.16 | 58.16 |
| Soybean meal, 48%, high | 130.00 | 6.50 | 130.00 | 6.50 |
| protein, dehulled, sol extracted | | | | |
| Corn DDGS, >6 and <9% Oil | 600.00 | 30.00 | 600.00 | 30.00 |
| Fat (Darling, Yellow Grease) | 20.00 | 1.00 | 20.00 | 1.00 |
| Monocalcium Phosphate | 16.00 | 0.80 | 16.00 | 0.80 |
| Limestone 2012 NRC | 34.00 | 1.70 | 34.00 | 1.70 |
| Sodium Chloride | 9.00 | 0.45 | 9.00 | 0.45 |
| L-Lysine | 4.00 | 0.20 | 3.70 | 0.185 |
| L-Threonine | 0.37 | 0.019 | 0.24 | 0.012 |
| Trace Mineral Premix | 3.00 | 0.15 | 3.00 | 0.15 |
| (NB-8534) | | | | |
| Vitamin Premix (NB-6508) | 5.00 | 0.25 | 5.00 | 0.25 |
| Ronozyme P (CT) | 0.30 | 0.015 | 0.30 | 0.015 |
| Ethoxiquin (Quinguard) | 0.60 | 0.03 | 0.60 | 0.03 |
| Sow Add Pack (NB-6442) | 5.00 | 0.25 | 5.00 | 0.25 |
| Peptiva Swine | 0.00 | 0.00 | 10.00 | 0.50 |
| Total | 2000 | 100 | 2000 | 100 |

| Calculate | Control | Peptive Swine |
|---|---|---|
| NSNG ME (kcal/kg) | 1.504 | 1.502 |
| CP (%) | 16.391 | 16.586 |
| SID Lysine (%) | 0.602 | 0.603 |
| Available P (%) | 0.308 | 0.311 |
| Aval. P (%) with phytase | 0.402 | 0.406 |
| Ca (%) | 0.851 | 0.853 |
| gSID Lysine/Mcal NSNG ME | 1.82 | 1.82 |
| SID M + C:Lys | 81.15 | 81.92 |
| SID Thr:Lys | 76.12 | 76.10 |
| SID Trp:Lys | 18.24 | 18.61 |
| SID Ile:Lys | 83.07 | 84.09 |
| SID Val:Lys | 103.25 | 104.45 |
| SID Leu:Lys | 251.79 | 253.23 |
| SID His:Lys | 60.60 | 61.23 |
| SID Arg:Lys | 116.02 | 117.74 |
| SID Phe:Lys | 110.39 | 111.39 |
| SID Phe + Tyr:Lys | 194.37 | 196.05 |

Lactation treatments: Sows were fed lactation diets starting at the time sows were moved to lactation (day 110). The compositions of the lactation diets are detailed in Table 5, below. The sows were fed these diets at the same level of intake through parturition. The lactation diet was provided ad libitum starting at 24 hours post-farrowing. Diets were fed in the meal form. Lactation treatments consisted of one of the following:
Lactation Treatment 1: Control−moderately complex diet.
Lactation Treatment 2: Treatment 1+Peptiva Swine.

TABLE 5
Lactation diet compositions.

| | University of Arkansas | | | |
|---|---|---|---|---|
| | PIC C29 × PIC 380 | | | |
| | Trial: Vitech Sows | | | |
| | Control | | Peptiva Swine | |
| | Lactation | | | |
| Ingredients | Lbs | % | Lbs | % |
| Corn, Yellow Dent | 1051.20 | 52.56 | 1041.67 | 52.08 |
| Soybean meal, 48%, high | 450.00 | 22.50 | 450.00 | 22.50 |
| protein, dehulled, sol extracted | | | | |
| Corn DDGS, >6 and <9% Oil | 400.00 | 20.00 | 400.00 | 20.00 |
| Fat (Darling, Yellow Grease) | 20.00 | 1.00 | 20.00 | 1.00 |
| Monocalcium Phosphate | 15.80 | 0.79 | 15.80 | 0.79 |
| Limestone 2012 NRC | 32.00 | 1.60 | 32.00 | 1.60 |
| Sodium Chloride | 10.00 | 0.50 | 10.00 | 0.50 |
| L-Lysine | 6.00 | 0.30 | 5.67 | 0.284 |
| L-Threonine | 1.10 | 0.055 | 0.96 | 0.048 |
| Trace Mineral Premix | 3.00 | 0.15 | 3.00 | 0.15 |
| (NB-8534) | | | | |
| Vitamin Premix (NB-6508) | 5.00 | 0.25 | 5.00 | 0.25 |
| Ronozyme P (CT) | 0.30 | 0.015 | 0.30 | 0.015 |
| Ethoxiquin (Quinguard) | 0.60 | 0.03 | 0.60 | 0.03 |
| Sow Add Pack (NB-6442) | 5.00 | 0.25 | 5.00 | 0.25 |
| Peptiva Swine | 0.00 | 0.00 | 10.00 | 0.50 |
| Total | 2000 | 100 | 2000 | 100 |

| Calculate | Control | Peptive Swine |
|---|---|---|
| NSNG ME (kcal/kg) | 1.498 | 1.496 |
| CP (%) | 20.936 | 21.128 |
| SID Lysine (%) | 1.036 | 1.036 |
| Total P (%) | 0.586 | 0.589 |
| Available P (%) | 0.310 | 0.314 |
| Aval. P (%) with phytase | 0.405 | 0.408 |
| Ca (%) | 0.857 | 0.859 |
| gSID Lysine/Mcal NSNG ME | 3.14 | 3.14 |
| SID M + C:Lys | 56.10 | 56.63 |
| SID Thr:Lys | 64.06 | 64.08 |
| SID Trp:Lys | 18.22 | 18.46 |
| SID Ile:Lys | 68.55 | 69.23 |
| SID Val:Lys | 78.06 | 78.87 |
| SID Leu:Lys | 164.23 | 165.34 |
| SID His:Lys | 46.26 | 46.69 |
| SID Arg:Lys | 105.98 | 107.11 |
| SID Phe:Lys | 84.10 | 84.80 |
| SID Tyr:Lys | 59.88 | 60.36 |
| SID Phe + Tyr:Lys | 143.77 | 144.96 |

### Results

Table 6 shows the effect of adding Peptiva to the diets of sows during gestation and lactation had on performance.

TABLE 6
Performance of sows fed one of two dietary treatments.

| | Treatment | | | Rep | Parity | Treatment |
|---|---|---|---|---|---|---|
| Variable | Control (1) | Peptiva (2) | SEM | P Value | P Value | P Value |
| Sinwt | | | | | | |
| swt110 (kg) | 253.79 | 255.15 | 3.705 | 0.0111 | 0.148 | 0.7946 |
| Sfarwt | 236.85 | 238.60 | 4.848 | 0.0079 | 0.2741 | 0.7976 |
| swnwt (kg) | 224.20 | 225.37 | 6.601 | 0.8585 | 0.1931 | 0.9004 |
| sgestgain (kg) | 42.83 | 44.19 | 3.705 | 0.0111 | 0.148 | 0.7946 |
| sowfarls (kg) | −16.94 | −16.55 | 3.449 | 0.2914 | 0.5193 | 0.9356 |
| slacls (kg) | −12.31 | −9.11 | 3.929 | 0.0019 | 0.1509 | 0.5654 |
| wk1adfi (kg) | 2.78 | 2.84 | 0.229 | 0.0004 | 0.7203 | 0.8501 |
| wk2&3adfi (kg) | 5.98 | 6.29 | 0.183 | <0.0001 | 0.778 | 0.231 |
| ovadfi (kg) | 4.48 | 4.67 | 0.143 | <0.0001 | 0.8485 | 0.3641 |
| nbl | 12.49 | 11.95 | 0.723 | 0.729 | 0.5845 | 0.5968 |
| tbwt (kg) | 16.88 | 18.28 | 1.097 | 0.2989 | 0.4615 | 0.3683 |
| avebwt (kg) | 1.31 | 1.49 | 0.052 | 0.0269 | 0.7442 | 0.0201 |
| still | 0.82 | 1.02 | 0.283 | 0.1434 | 0.6089 | 0.6212 |
| mum | 0.06 | 0.06 | 0.072 | 0.3572 | 0.2638 | 0.9909 |
| ndead | 1.84 | 1.34 | 0.326 | 0.4917 | 0.6886 | 0.285 |
| ntranfr | 0.14 | 0.03 | 0.096 | 0.7541 | 0.233 | 0.4554 |
| nwean | 10.79 | 10.65 | 0.557 | 0.4081 | 0.2862 | 0.8555 |
| twnwt (kg) | 64.39 | 64.78 | 2.684 | 0.9105 | 0.0372 | 0.9179 |
| avewnwt | 6.08 | 6.33 | 0.205 | 0.0632 | 0.7507 | 0.3872 |
| pigadg (gr) | 0.24 | 0.25 | 0.009 | 0.1793 | 0.8253 | 0.7857 |

s110wt = sow weight 110 day weight (kg).
sfarwt = sow weight farrowing (kg).
swnwt = Sow Weaning Weight (kg).
sgestgain = Sow Gestation Gain (kg).
sowfarls = Sow Farrowing Weight Loss (kg).
slacls = Sow Lactation Weight Loss (kg).
wk1adfi = Week 1 Lactation Average Daily Feed Intake (kg).
wk2adfi = Week 2 Lactation Average Daily Feed Intake (kg).
wk3adfi = Week 3 Lactation Average Daily Feed Intake (kg).
ovadfi = Overall Lactation Average Daily Feed Intake (kg).
nbl = Number Born Live.
Tbwt = Total Birth Weight (kg).
avebwt = Average Birth Weight (kg).
still = Number of Stillborn.
Mum = Number of Mummies.
ndead = Number of Lactation Dead.
Ntranfr = Number of Pigs Transferred.
Nwean = Number Weaned.
Twnwt = Total Weaning Weight (kg).
awntwt = Average Weaning Weight (kg).
Pigadg = Piglet Average Daily Gain (gr).

The overall performance in this study was very good and only two sows were removed due to health or lameness issues.

Data were collected from 25 sows fed the control diet and from 22 sows fed the Peptiva diet. Feeding the sows Peptiva from day 93 of gestation through lactation increased birth weight by 0.18 kg (13.7 percent; p<0.05). Total litter birth weight differences were not significant but litter birth weight was increased by 1.4 kg (p=0.37). Although not significant, pig weaning weight was increased by 0.25 kg (p=0.39) in pigs fed Peptiva, and piglet average daily gain was increased by 0.01 kg/d. Peptiva supplementation also tended to increase sow feed intake during weeks 2 and 3 (0.31 kg/d; p=0.23) as well as the overall average daily feed intake (0.19 kg/d; p=0.36).

These improvements in birth weight and sow feed intake improved pre-weaning pig survival from 88.4% of those born alive to 91.1%, although the differences were not significant (p=0.30). The improvements in pig birth weight and sow intake also resulted in non-significant reductions in the percentage of weaned pigs weighing less than 7 lbs, which was reduced from 11.11% to 8.87% (p=0.39).

We are not aware of any other study that has produced a similar enhancement in pig birth weight. While the magnitude of the improvement in lactation performance is not as great as one might expect but based on previous work (J. Anita. Sci. 1989. 67:3-14), one would expect to see significant effects with greater numbers of pigs. These effects may be even greater in an industry setting.

In summary, this preliminary study suggests that dietary supplementation with Peptiva may impact reproduction and significantly enhance subsequent pre-weaning piglet survival, health, and performance.

I claim:

1. A feed supplement comprising a fish-derived hydrolysate peptide composition and zinc oxide.

2. The feed supplement of claim 1, wherein the fish-derived hydrolysate peptide and zinc oxide are present in a ratio of 1:7 to 10:7 by weight.

3. The feed supplement of claim 1, wherein the fish-derived hydrolysate peptide composition comprises 50-80 wt % of protein.

4. The feed supplement of claim 1, wherein the fish-derived hydrolysate peptide composition comprises 4-8 wt % of fat.

5. The feed supplement of claim 1, wherein the fish-derived hydrolysate peptide composition comprises 2-3 wt % of fiber.

6. An animal food product comprising the feed supplement of claim 1.

7. The animal food product of claim 6, wherein the feed supplement is 1-10 wt % of the animal food product.

8. The animal food product of claim 6, wherein the feed supplement is 2-5 wt % of the animal food product.

9. The animal food product of claim 8, further comprising corn, soy, fat and milk whey powder.

10. A method of feeding swine by supplying the feed supplement claim 1 or a swine food product made therefrom to swine.

11. The method of claim 10, wherein the swine are nursery piglets.

12. The method of claim 11, wherein the method results in an increase in average daily gain, an increase in body weight, an increase in average daily feed intake, a increase in the ratio of weight gain to feed, or a combination thereof, of the nursery piglets as compared to the nursery piglets fed with feed supplement or food product lacking the fish-derived hydrolysate peptide composition and zinc oxide.

13. The method of claim 10, wherein the swine are gestating sows.

14. The method of claim 13, wherein the method results in an increase in sow weight of the gestating sows or an increase in the sow weight at farrowing as compared to the gestating sows fed with feed supplement or food product lacking the fish-derived hydrolysate peptide composition and zinc oxide.

15. The method of claim 13, wherein the method results in an increase in birth weight of piglets born, or a decrease in the number of dead piglets born from gestating sows as compared to piglets born from gestating sows fed with feed supplement or food product lacking the fish-derived hydrolysate peptide composition and zinc oxide.

16. The method of claim 10, wherein the swine are lactating sows.

17. The method of claim 16, wherein the method results in an increase in feed intake of the lactating sows as compared to the lactating sows fed with feed supplement or food product lacking the fish-derived hydrolysate peptide composition and zinc oxide.

18. The method of claim 16, wherein the method results in a decrease in weight loss of the lactating sows as compared to the lactating sows fed with feed supplement or food product lacking the fish-derived hydrolysate peptide composition and zinc oxide.

19. The method of claim 13, wherein the method results in an increase in weaning weight, average daily gain, or a combination thereof of piglets born/lactating from treated sows as compared to piglets born/lactating from sows fed with feed supplement or food product lacking the fish-derived hydrolysate peptide composition and zinc oxide.

20. The method of claim 13, wherein the method results in an increase in pre-weaning piglet survival, a decrease in the number of piglets requiring transferor a decrease in weaned pigs weighing less than 7 pounds of piglets born/lactating from treated sows as compared to piglets born/lactating from sows fed with feed supplement or food product lacking the fish-derived hydrolysate peptide composition and zinc oxide.

21. The method of claim 13, wherein the method results in better weight gain: feed ratio and better adsorption of amino acids.
